(19) United States
(12) Patent Application Publication
(10) Pub. No.: US 2006/0022371 A1
(43) Pub. Date: Feb. 2, 2006

(54) Method for forming compact from powder and mold apparatus for powder forming

(75) Inventors: Takashi Nakai, Niigata (JP); Kinya Kawase, Niigata (JP)

Correspondence Address: DARBY & DARBY P.C., P. O. BOX 5257, NEW YORK, NY, 10150-5257, US

(73) Assignee: Mitsubishi Materials Corporation, Tokyo (JP)

(21) Appl. No.: 10/531,813

(22) PCT Filed: Nov. 18, 2003
(86) PCT No.: PCT/JP03/14643

§ 371 Date: Apr. 18, 2005

(30) Foreign Application Priority Data
Nov. 21, 2002 (JP) 2002-338621

(51) Int. Cl. B27N 3/00

(52) U.S. Cl. 264/109; 425/354

(57) ABSTRACT

A method for forming a compact from a powder wherein a forming portion 1A in a mold body 2 is filled with a raw powder and upper and lower punches 3,4 are fitted into the forming portion 1A to form the compact. Prior to filling the forming portion 1A with the raw powder M, a solution L with a lubricant being uniformly dissolved in a solvent is applied to a peripheral portion of the forming portion 1A, and then the solution is evaporated, thus forming a crystallized layer B thereon. Thus, the reduction of a force for ejecting the compact is realized, while improving the density of the compact, realizing the stable and successive production of the compact

### FIELD OF THE INVENTION

The present invention relates to a method for forming a compact from a powder by filling raw powders in a mold for powder molding, and also relates to a mold apparatus for such powder molding.

### DESCRIPTION OF THE RELATED ART

A green compact, which is used for the production of sintered products, is formed by pressing raw powders such as Fe-based powders, Cu-based powders or the like in a mold, and then a sintered body is formed through a sintering process. In the molding process, the compact undergoes a press-molding process, using a mold. At the time of the press-molding, however, a friction between a compact and a mold is generated. For this reason, when mixing raw powders, a water-insoluble fatty acid lubricant, such as zinc stearate, calcium stearate, lithium stearate, etc., is added so as to impart lubricity.

However, the method of applying a lubricant to raw powders has limitations of improvement of the density of a compact. Accordingly, in order to obtain a high-density compact, there is proposed a method for forming a compact which can make up for the lack of lubricity by applying the same lubricant as the one added to raw powders to a mold while reducing the amount of lubricant added to raw powders.

This conventional method of molding is disclosed in, for example, Japanese Registered Patent Publication No. 3309970 (see paragraphs 0012 and 0013). This method comprises steps of: applying water dispersed in a high fatty acid lubricant to an inner surface of a heated mold by a spray gun so as to coat the inner surface therewith; and press-molding metal powders by filling the metal powders in the mold and pressing the same at such a pressure that the high fatty acid lubricant is chemically bonded to the metal powders so as to produce a film of metallic soap, wherein the mold is heated, and the inner surface thereof is coated with the high fatty acid lubricant such as lithium stearate; heated metal powders are filled into this mold and are subjected to press-molding at such pressure that the high fatty acid lubricant is chemically bonded to the metal powders so as to produce the film of metallic soap, whereby the film of metallic soap is produced on the inner surface of the mold to thereby reduce the friction between the compact of the metallic powders and the mold, thereby enabling the reduction of force for ejecting the compact.

As the fact that the same lubricant as one added to the raw powders is used for the mold results in the use of the water-insoluble lubricant, the lubricant applied to the metal is applied in a solid state. For this reason, other lubricant application methods are also known, such as electrostatic application of lubricant powders or dry application of lubricant which is dispersed in water by detergent and then dried.

According to the conventional art disclosed in the above documents, however, since the lubricant dispersed in water is applied to the mold in a state of solid powders, that is, in such state that the solid powders of the lubricant are dispersed and mixed in water, a fine film can not be formed, and thus there is a problem that producing a compact of a stable quality is difficult.

The present invention has been made to solve the above problems. It is, accordingly, an object of the present invention to provide a method for forming a compact which enables the stable production of a high density compact by forming a fine and uniform film of lubricant on a forming portion.

Another object thereof is to provide a mold apparatus for use in powder molding which enables a high density compact to be stably produced by forming a fine and uniform film of lubricant on a forming portion.

### SUMMARY OF THE INVENTION

In order to attain the above objects, a first aspect of the present invention proposes a method for forming a compact from a powder, including the steps of filling a forming portion in a mold body with a raw powder; and then inserting upper and lower punches into the forming portion to thereby form the compact, wherein prior to filling the forming portion with the raw powder, a solution with a lubricant dissolved in a solvent is applied to a peripheral surface of the forming portion, and then the solution is evaporated to thereby provide a crystallized layer on the forming portion. Thus, a fine crystallized layer for lubrication on the forming portion reduces force for ejecting the compact from the mold body, and improves the density thereof.

In the above described method, one or more lubricants may be selected from a group of oxo acid system metal salts.

Alternatively, the solution may eventually result in a thickness of the crystallized layer by completely solving a water-soluble lubricant in water in the solution so that a concentration of the lubricant is greater than or equal to the concentration resulting from one molecule of the lubricant, but less than the concentration of the saturated solution.

The lubricant may be a potassium or sodium salt. An antiseptic agent, a defoaming agent and/or a water-soluble agent may be added to the lubricant. The water-soluble solvent may be alcohol or ketone. The lubricant may be free of Halogen family of element, thereby ensuring the forming of a fine crystallized lubricating layer on the forming portion.

According to the foregoing method for forming a compact, for example, the solution of metal phosphate such as dipotassium hydrogen phosphate, disodium hydrogen phosphate or the like is completely dissolved in water into a uniform phase in concentrations not less than 1 ppm but less than saturated concentration, and then it is applied to the surface of the forming portion and evaporated to thereby allow the crystals of the lubricant to be grown on the surface of the forming portion so as to form the crystallized layer.

In order to attain the above objects, a second aspect of the present invention proposes a mold apparatus for powder molding, comprising: a mold body with a through-hole for forming a side of a compact; a lower punch to be fitted into the through-hole from beneath; an upper punch to be fitted into the through-hole from above; a spray pump from which a lubricant solution is sprayed to the through-hole; a heater provided around a forming portion of the mold body, the forming portion being defined by the through-hole and the lower punch; and a temperature control system keeping a temperature of the heater higher than an evaporating temperature of the solution.

Alternatively, there may be provided a mold body with a through-hole for forming a side of a compact; a lower punch to be fitted into the through-hole from beneath; an upper punch to be fitted into the through-hole from above; a spray pump from which a lubricant solution may be sprayed to the through-hole; a heater around a forming portion of the mold body, the forming portion being defined by the through-hole and the lower punch; and a temperature control system keeping a temperature of the heater higher than an evaporating temperature of the solution, but lower than a melting temperature of the lubricant.

According to the foregoing structures of the mold apparatus of the invention, the solution of the lubricant is applied to the pre-heated forming portion prior to a raw powder being filled in the forming portion defined by the through-hole in the mold body and the lower punch to be fitted into the through-hole, so that the solution is evaporated to thereby form a fine crystallized layer on the surface of the forming portion. Thereafter, the forming portion is filled with a raw powder, and then the upper punch is fitted from above into the through-hole, to thereby form a compact. According to the invention, a fine crystallized layer resulting from the lubricant solution is reliably formed on the forming portion of the mold, thus enabling the reduction of a force for ejecting the compact as well as the improvement of the density of the compact, realizing the stable and successive production of the compact.

### BRIEF DESCRIPTION OF THE DRAWINGS

FIG. 1A is a schematic diagram showing a first process according to a first embodiment of the present invention;

FIG. 1B is a partly enlarged cross-sectional view showing a part P of a mold according to the first embodiment;

FIG. 2 is a schematic diagram showing a second process according to the first embodiment of the present invention;

FIG. 3 is a schematic diagram showing a third process according to the first embodiment of the present invention; and

FIG. 4 is a schematic diagram showing a fourth process according to the first embodiment of the present invention.

### DETAILED DESCRIPTION OF THE PREFERRED EMBODIMENT

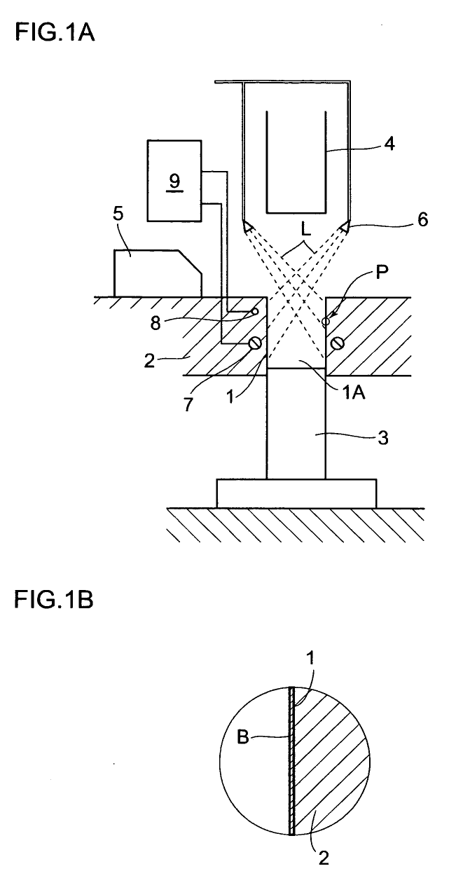

A first embodiment of the present invention will now be explained with reference to FIGS. 1 to 4. In FIG. 1A showing a first process, numeral 1 designates a through-hole formed in a die 2 serving as a mold for forming sides of a compact A as a later-described powder molded body. A lower punch 3 is fitted into the through-hole 1 from the underneath thereof and an upper punch 4 is also fitted into the through-hole 1 from the above thereof. A feeder 5, which provides a raw powder M, is slidably provided on an upper surface of the die 2. Above the through-hole 1 is provided a spray member 6 serving as a solution applying means for spraying a lubricant solution L so as to attach the same to a forming portion 1A of the mold. The spray member 6 is arranged so as to face the through-hole 1, and is connected to a tank of the solution L (not shown) via an automatically openable and closable valve (not shown). A heater 7 and a temperature detector 8 are provided around the periphery of the forming portion 1A for forming the compact A, the forming portion being defined by the through-hole 1 and the lower punch 3 engaged therewith. The heater 7 and the temperature detector 8 are connected to a temperature control device 9 serving as a temperature controlling means, which keeps temperature in the through-hole 1 higher than the evaporating temperature of the solution, and lower than the melting temperature of the lubricant.

In the first process, due to the heat of the heater 7 being pre-controlled by the temperature control system 9, the temperature of the periphery of the through-hole 1 is kept higher than the evaporating temperature of the solution L, and lower than the melting temperature of the lubricant beforehand. Then, the automatically openable and closable valve is opened to apply the solution L of the lubricant by spraying from the spray member 6 to the forming portion 1A of the die 2 heated by the heater 7, with the lower punch 3 being fitted into the through-hole 1 to define the forming portion 1A. As a result, the solution L is evaporated and dried out, and thus crystals are allowed to grow on the peripheral surface of the through-hole 1, so that a crystallized layer B of the lubricant is uniformly formed as shown in FIG. 1B.

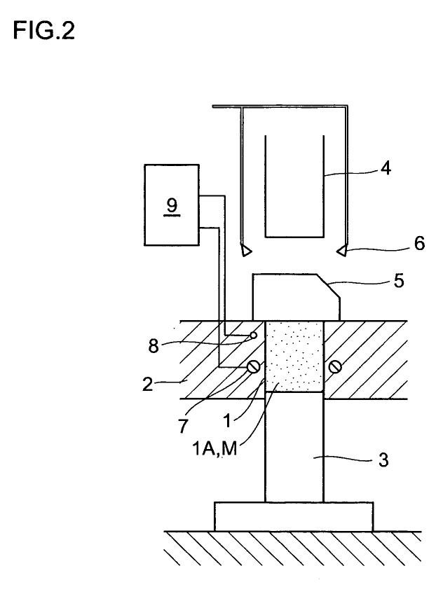

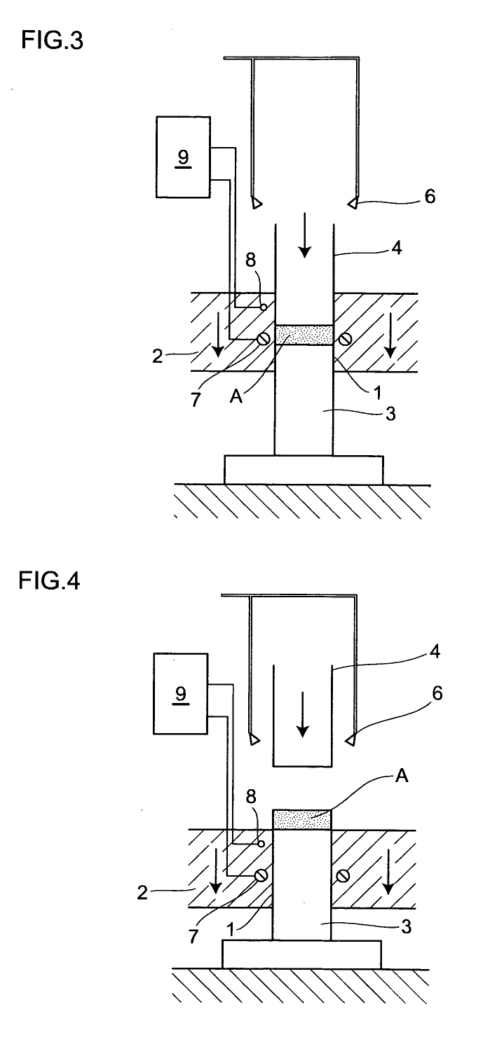

Next, as illustrated in a second process shown in FIG. 2, the feeder 5 is moved forward so as to drop a raw powder M into the forming portion 1A to fill the same therewith. Subsequently, as illustrated in a third process shown in FIG. 3, the die 2 is moved downwardly, while the upper punch 4 is inserted into the forming portion 1A of the through-hole 1 from thereabove, so that the raw powder M is compressed in a manner that is sandwiched between the upper punch 4 and the lower punch 3. At this stage, a bottom end of the lower punch 3 is firmly held in position. In this third process, the material powder M is compressed by being pressed against the crystallized layer B formed of the lubricant with a lubrication property being imparted thereto by the layer B.

The compact A thus press-molded becomes ejectable when the die 2 is moved further downwardly until the upper surface of the die 2 becomes essentially as high as the lower surface of the lower punch 3, as illustrated in a fourth process shown in FIG. 4. When ejecting the same, the compact A is allowed to contact the crystallized layer B that is formed of the lubricant and is in a lubricated condition, like in the third process. After ejecting the compact A thus way, the first process is repeated and thus the solution L is applied to the forming portion 1A again to form the crystallized layer B, and then the raw powder M is filled into the forming portion 1A.

Preferred examples and comparative examples will now be explained with reference to Tables 1 to 3. In each of the preferred examples and comparative examples shown in Tables 1 to 3, iron powders (average particle diameter: 90, m) were used as the raw powder, to which was added 0.2% by weight of Lithium stearate (average particle diameter: 5, m) serving as the lubricant, which were then stirred for 30 minutes using a rotary mixer, so that 7 g of the resultant mixture of the raw powder was filled into a mold forming a cylindrical column having a 1 cm² pressurization area, and then 100 compacts were successively formed at a forming pressure of 8 t/cm². In the preferred examples, after the solution of the water-soluble lubricant dissolved in water was applied to the forming portion heated at 150 deg C. in the mold, it was evaporated and dried to form the crystallized layer, and then the raw powders were filled into this forming portion. In the comparative example 1, after the solution of lithium stearate dispersed in acetone was applied to the forming portion of the mold heated at 150 deg C., it was evaporated and dried to form the crystallized layer, and then the material powders were filled into this forming portion. The comparative example 2 is a case in which the lubricant was not applied to the mold. Density R in each Table shows difference between maximum and minimum values in the density of 100 compacted bodies continuously molded.

TABLE 1

| | 1^{st} ex. | 2^{nd} ex. | 3^{rd} ex. | 4^{th} ex. | 5^{th} ex. | 6^{th} ex. | 7^{th} ex. | 8^{th} ex. | 9^{th} ex. |
|---|---|---|---|---|---|---|---|---|---|
| A | dipotassium | disodium | trisodium | sodium | Riboflavin | potassium | sodium | sodium | sodium |
| | hydrogen | hydrogen | phosphate | polyphosphate | sodium | sulfate | sulfite | thiosulfate | dodecyl- |
| | phosphate | phosphate | | | phosphate | | | | sulfate |
| B | water | Water | water | Water | Water | water | water | water | water |
| C | dissolved | dissolved | dissolved | dissolved | Dissolved | dissolved | dissolved | dissolved | dissolved |
| D | 1% | 1% | 1% | 1% | 1% | 1% | 1% | 1% | 1% |
| E | 150 deg C. | 150 deg C. | 150 deg C. | 150 deg C. | 150 deg C. | 150 deg C. | 150 deg C. | 150 deg C. | 150 deg C. |
| F | 6k N | 8k N | 6k N | 8k N | 20k N | 18k N | 20k N | 18k N | 16k N |
| G | 7.56 g/cm³ | 7.55 g/cm³ | 7.56 g/cm³ | 7.54 g/cm³ | 7.50 g/cm³ | 7.52 g/cm³ | 7.50 g/cm³ | 7.51 g/cm³ | 7.53 g/cm³ |
| H | 0.02 | 0.02 | 0.02 | 0.02 | 0.03 | 0.02 | 0.02 | 0.02 | 0.03 |

A Mold lubricating composition
B Solvent
C State of lubricating composition
D Concentration
E Forming temperature
F Average ejecting force
G Average compact density
H Density R

TABLE 2

| | 10^{th} ex. | 11^{th} ex. | 12^{th} ex. | 13^{th} ex. | 14^{th} ex. | 15^{th} ex. | 16^{th} ex. | 17^{th} ex. | 18^{th} ex. |
|---|---|---|---|---|---|---|---|---|---|
| A | sodium | Food | Food | sodium | sodium | sodium | sodium | sodium | sodium |
| | dodecylbenzene- | Blue No. 1 | Yellow | ascorbyl | tetraborate | silicate | tungstate | acetate | benzoate, |
| | sulfonate | | No.5 | sulfate | | | | | |
| B | water | water | water | Water | water | water | water | water | water |
| C | dissolved | dissolved | dissolved | dissolved | dissolved | dissolved | dissolved | dissolved | dissolved |
| D | 1% | 1% | 1% | 1% | 1% | 1% | 1% | 1% | 1% |
| E | 150 deg C. | 150 deg C. | 150 deg C. | 150 deg C. | 150 deg C. | 150 deg C. | 150 deg C. | 150 deg C. | 150 deg C. |
| F | 16k N | 16k N | 20k N | 8k N | 8k N | 10k N | 12k N | 18k N | 10k N |
| G | 7.53 g/cm³ | 7.53 g/cm³ | 7.51 g/cm³ | 7.54 g/cm³ | 7.54 g/cm³ | 7.54 g/cm³ | 7.53 g/cm³ | 7.51 g/cm³ | 7.54 g/cm³ |
| H | 0.02 | 0.03 | 0.04 | 0.02 | 0.02 | 0.03 | 0.03 | 0.02 | 0.02 |

TABLE 3

| | 20^{th} ex. | 21^{st} ex. | 22^{nd} ex. | 23^{rd} ex. | 24^{th} ex. | 25^{th} ex. | 1^{st} c. ex. | 2^{nd} c. ex. |
|---|---|---|---|---|---|---|---|---|
| A | sodium | sodium | potassium | sodium | sodium | potassium | lithium | none |
| | ascorbate | stearate | stearate | hydrogen | carbonate | nitrate | stearate | |
| | | | | carbonate | | | | |
| B | water | water | water | Water | water | water | acetone | |
| C | dissolved | dissolved | dissolved | dissolved | dissolved | dissolved | dispersed | |
| D | 1% | 0.2% | 0.5% | 1% | 1% | 1% | 1% | |
| E | 150 deg C. | 150 deg C. | 150 deg C. | 150 deg C. | 150 deg C. | 150 deg C. | 150 deg C. | 150 deg C. |
| F | 16k N | 16k N | 14k N | 18k N | 18k N | 20k N | 22k N | 32k N |
| G | 7.53 g/cm³ | 7.52 g/cm³ | 7.53 g/cm³ | 7.51 g/cm³ | 7.52 g/cm³ | 7.51 g/cm³ | 7.50 g/cm³ | 7.48 g/cm³ |
| H | 0.02 | 0.04 | 0.04 | 0.03 | 0.02 | 0.04 | 0.20 | 0.16 |

c. ex. comparative example

Comparison result from Tables 1 to 3 indicates that the force required for ejecting a compact from a die in the examples were less than or equal to that of the comparative example 1. Besides, the densities were improved in the examples as compared to the comparative example 1. Moreover, the densities R in the examples noticeably became smaller than that of the comparative example 1. Therefore, it is apparent from the result that the high-density molding can be stably carried out according to the preferred examples, even though it is carried out successively.

As is clearly indicated in Tables 1 to 3, the aforesaid lubricant may preferably be a water-soluble phosphate based metal salt, or the one having a phosphate group in its structure, such as dipotassium hydrogen phosphate, disodium hydrogen phosphate, tripotassium phosphate, trisodium phosphate, potassium polyphosphate, sodium polyphosphate, riboflavin potassium phosphate, riboflavin sodium phosphate or the like.

As is also seen from Tables 1 to 3, it is preferable that, as a soluble sulfate-based salt, the lubricant may include a sulfate-based group in its structure, such as potassium sulfate, sodium sulfate, potassium sulfite, sodium sulfite, potassium thiosulfate, sodium thiosulfate, potassium dodecyl sulfate, sodium dodecyl sulfate, potassium dodecylbenzensulfonate, sodium dodecylbenzenesulfonate, Food Blue No. 1. (i.e., C₃₇H₃₄N₂Na₂O₉S₃), Food Yellow No. 5. (i.e., C₁₆H₁₀N₂Na₂O₇S₂), potassium ascorbyl sulfate, sodium ascorbyl sulfate.

As is also seen from Tables 1 to 3, it is preferable that, as a soluble borate-based metal salt, the lubricant may include a borate-based group in its structure, such as potassium tetraborate, sodium tetraborate.

Tables 1 to 3 also show that it is preferable that, as a soluble silicate-based metal salt, the lubricant may include a silicate-based group in its structure, such as potassium silicate, sodium silicate.

Still also, Tables 1 to 3 show that it is preferable that, as a soluble tungstate-based metal salt, the lubricant may include a tungstate-based group in its structure, such as potassium tungstate or sodium tungstate.

Table 1 to 3 show that it is preferable that, as a soluble organic-acid-based metal salt, the lubricant may include an organic-acid-based group in its structure, such as potassium acetate, sodium acetate, potassium benzoate, sodium benzoate, potassium ascorbate, sodium ascorbate, potassium stearate or sodium stearate.

It is also seen from Tables 1 to 3, that it is preferable that, as a soluble nitrate-based metal salt, the lubricant may include a nitrate-based group in its structure such as potassium nitrate, sodium nitrate.

It is still also seen from Tables 1 to 3 that it is preferable that, as a soluble carbonate-based metal salt, the lubricant may include a carbonate-based group in its structure, such as potassium carbonate, sodium carbonate, potassium hydrogen carbonate or sodium hydrogen carbonate.

Alternatively, one or more of the foregoing lubricants may be used as the lubricant.

The water-soluble lubricant should have a concentration greater than or equal to a concentration defined by one molecule of the lubricant forming the thickness of the crystallized layer, but less than a concentration of a saturated solution. More specifically, the concentration should range from 1 ppm to the concentration of the saturated solution. This is because the concentration of less than 1 ppm makes it difficult to obtain a stably lubricating crystallized layer unless the lubricant is applied to the mold body in large quantities, while the saturated concentration or above does not allow the lubricant to be completely dissolved so that it is precipitated as a solid, thus casing troubles such as the clogging of the spray pump 6 when applying lubricant using the same.

For dissolvent water, water from which metal and halogen elements are removed is preferable, such as distilled water or ion-exchange water. This is because some lubricants, though it depends on a kind thereof, are precipitated due to the readiness to substitute metal components in water, thus casing troubles, while water containing a large amount of halogen components is likely to cause a bond to a compact or to produce a harmful substance such as dioxin or the like during a sintering process.

Further, some lubricants, though also depending on a kind thereof, facilitate the growing of microorganisms and thus the solution is easily decayed, thereby causing a change in components, emitting bad smell. However, adding an antiseptic agent can prevent the growing of microorganisms. For the antiseptic agent, it is preferable to use one which does not impair lubrication property, produces low harmful effects to a human body, and includes no halogen components, such as sodium benzoate or the like.

Furthermore, some lubricants have a problem that foaming easily occurs, and thus when the solution (L) is applied to the forming portion (1A), such forming is likely to occur so that a raw powder is caked. However, by adding a water-soluble solvent such as alcohol or ketone, or a defoaming agent, such foaming can be prevented. For alcohol or ketone, it is preferable to use one which does not impair the lubricating action, causes less damages to a human body, and does not include halogen components, such as ethanol, acetone or the like.

In some cases, using a water-soluble solvent such as alcohol and ketone with a lower boiling point or a lower latent heat of evaporation than water can reduce hours for evaporation or dry, eliminating the need for keeping the mold body 2 at high temperature.

In a case where these lubricants, additives or dissolvent water include halogen elements, a substance that is highly toxic even in minute amounts such as dioxin is likely to be created under such a condition that sintering is performed with carbon components being coexistent, as is often used in powder metallurgy of iron. Therefore it is preferable to include no halogen elements therein.

As for the temperature of the mold body 2 and the mixed raw powder M, keeping them at high temperature is desirable because it contributes to reduction of hours for drying, accompanied by effects of warm forming and the like. If there is caused no particular trouble, however, it can be kept at ordinary temperature. On the other hand, when setting them at high temperature, it is preferable to choose such a lubricant that is not melt down at a preset temperature, since the melt lubricant makes it difficult to stably perform warm compaction due to the melt lubricant caking a raw powder, flowing down to the bottom of the die (the forming portion 1A). If there is caused no particular trouble, however, it may be in a semi-molten state, in a highly viscous state, or otherwise, at least one lubricant of the mixed two ore more lubricants may be in a molten state. Since zinc stearate and lithium stearate that have been conventionally used have melting temperatures of about 120 deg C. and about 220 deg C., respectively, it has heretofore been difficult to stably perform warm compaction at a temperature higher than these temperatures. Among the lubricants proposed in the present invention, however, there are a number of lubricants that have a higher melting point than 220 deg C., and some of them have a higher melting point than 1000 deg C. Therefore it is possible to easily and stably perform warm compaction by raising the temperature up to an upper temperature limit of the die (the forming portion 1A) or almost to an oxidization temperature of the raw powder. In that case, however, there occur problems such as fluidity of the raw powder, and thus it is preferable to use the lubricant that does not melt even under high temperature, as the one to be added into the mixed raw powder M. For example, the powdery lubricants of the present invention or solid lubricants such as graphite or molybdenum disulfide are preferable. Alternatively, it is also preferable to form the compact only by lubrication of the mold body itself without using the lubricant.

According to the description of the foregoing embodiment, there is provided a method for forming a compact from a powder, including the steps of filling the forming portion 1A in the mold body 2 with the raw powder M; and then inserting upper and lower punches 3, 4 into the forming portion 1A to thereby form the compact, wherein prior to filling the forming portion 1A with the raw powder M, the solution L with a lubricant dissolved in a solvent to a uniform phase is applied to the forming portion 1A, and then the solution L is evaporated to thereby form the crystallized layer B on the forming portion 1A. Thus, the fine crystallized layer B for lubrication is formed on the peripheral surface of the forming portion 1A, thereby enabling the reducing of a force required for ejecting the compact A from the forming portion 1A as well as the improving of the density thereof.

Also, according to the foregoing embodiment, there is provided a mold apparatus for powder molding, comprising: the mold body 2 with the through-hole 1 for forming a side of the compact A; the lower punch 3 to be fitted into the through-hole 1 from beneath; the upper punch 4 to be fitted into the through-hole 1 from above; the spray pump 6 from which the lubricant solution L is sprayed to the through-hole 1; the heater 7 provided around the forming portion 1A of the mold body 2, the forming portion 1A being defined by the through-hole 1 and the lower punch 3; and the temperature control system 9 keeping a temperature of the heater 7 higher than an evaporating temperature of the solution L, but lower than a melting temperature of the lubricant.

Thus, the solution L of the lubricant is applied to the pre-heated forming portion 1A prior to the raw powder M being filled in the forming portion 1A, so that the solution L is evaporated to thereby form the fine crystallized layer B on the peripheral surface of the forming portion 1A. Accordingly, the fine crystallized layer B is reliably formed on the peripheral surface of the forming portion 1A, thus enabling the reduction of a force for ejecting the compact A from the forming portion 1A as well as the improvement of the density of the compact A, realizing the stable and successive production of the compact A.

The present invention is not limited to the forgoing embodiment but may be modified within the scope of the invention. The solution in which the lubricant is dissolved in the solvent in the foregoing embodiment may be the one in which a part of the lubricant is dissolved in the solvent, can be used. Although in the foregoing embodiment, the solution is applied to the forming portion and then evaporated to form the crystallized layer on the forming portion prior to filling the raw powder, and then the punches fitted into the forming portion to thereby form the compact powder, it is not always necessary to form the crystallized layer on the forming portion by applying the solution thereto and then evaporating the same, prior to filling the raw powder. For example, after forming a first compact, a second compact may be formed by filling a second raw powder, utilizing the crystallized layer formed when the first compact is formed, without applying the solution to the forming portion, and then the solution may be applied to the forming portion prior to filling a third raw powder, and then it is evaporated, to thereby form a second crystallized layer on the forming portion. The solution may be applied to the forming portion in such an intermittent manner.

1. A method for forming a compact from a powder, comprising the steps of:
applying a solution obtained by dissolving a lubricant in a solvent to a forming portion of a mold body;
evaporating the solution to form a crystallized layer on a surface of the forming portion; filling the forming portion of the mold body with a raw powders; and fitting upper and lower punches into the forming portion.

2. The method for forming a compact from a powder according to claim 1, wherein the lubricant comprises an oxo-acid-based metal salt.

3. The method for forming a compact from a powder according to claim 1, wherein the lubricant is at least one selected from a group consisting of a phosphate metal salt, a sulfate metal salt, a borate metal salt, a silicate metal salt, a tungstate metal salt, an organic-acid-based metal salt, a nitrate metal salt and a carbonate metal salt.

4. The method for forming a compact from a powder according to claim 3, wherein the lubricant is at least one selected from a group consisting of dipotassium hydrogen phosphate, disodium hydrogen phosphate, tripotassium phosphate, trisodium phosphate, potassium polyphosphate, sodium polyphosphate, riboflavin potassium phosphate and riboflavin sodium phosphate.

5. The method for forming a compact from a powder according to claim 3, wherein the lubricant is at least one selected from a group consisting of potassium sulfate, sodium sulfate, potassium sulfite, sodium sulfite, potassium thiosulfate, sodium thiosulfate, potassium dodecyl sulfate, sodium dodecyl sulfate, potassium dodecylbenzensulfonate, sodium dodecylbenzenesulfonate, Food Blue No. 1., Food Yellow No. 5., potassium ascorbyl sulfate and sodium ascorbyl sulfate.

6. The method for forming a compact from a powder according to claim 3, wherein the lubricant is potassium tetraborate or sodium tetraborate.

7. The method for forming a compact from a powder according to claim 3, wherein the lubricant is potassium silicate or sodium silicate.

8. The method for forming a compact from a powder according to claim 3, wherein the lubricant is potassium tungstate or sodium tungstate.

9. The method for forming a compact from a powder according to claim 3, wherein the lubricant is at least one selected from a group consisting of potassium acetate, sodium acetate, potassium benzoate, sodium benzoate, potassium ascorbate, sodium ascorbate, potassium stearate and sodium stearate.

10. The method for forming a compact from a powder according to claim 3, wherein the lubricant is potassium nitrate or sodium nitrate.

11. The method for forming a compact from a powder according to claim 3, wherein the lubricant is at least one of potassium carbonate, sodium carbonate, potassium hydrogen carbonate and sodium hydrogen carbonate.

12. (canceled)

13. The method for forming a compact from a powder according to claim 1, wherein said solution has said lubricant completely dissolved in water to have a concentration greater than or equal to a concentration at which the thickness of a crystallized layer is formed by one molecule of the lubricant, but less than a concentration of a saturated solution.

14. The method for forming a compact from a powder according to claim 13, wherein the lubricant is a potassium salt or a sodium salt.

15. The method for forming a compact from a powder set forth in claim 1, wherein an antiseptic substance is added into the lubricant.

16. The method for forming a compact from a powder set forth in claim 1, wherein a defoaming agent is added into the lubricant.

17. The method for forming a compact from a powder set forth in claim 1, wherein soluble solvent is added into the lubricant.

18. The method for forming a compact from a powder according to claim 17, wherein said solvent is alcohol or ketone.

19. The method for forming a compact from a powder according to claim 1, wherein no halogen element is included in the lubricant.

20. A mold apparatus for powder molding, comprising:
a mold body with a through-hole for forming a side of a compact;
a lower punch for fitting into the through-hole from beneath;
an upper punch for fittingh into the through-hole from above;
a spray pump for spraying a lubricant solution to the through-hole;
a heater provided around a forming portion of the mold body, the forming portion being defined by the through-hole and the lower punch; and
a temperature control system for keeping a temperature of the heater higher than an evaporating temperature of the solution.

21. A mold apparatus for powder molding, comprising:
a mold body with a through-hole for forming a side of a compact;
a lower punch for fitting into the through-hole from beneath;
an upper punch for fitting into the through-hole from above;
a spray pump for spraying a lubricant solution to the through-hole;
a heater provided around a forming portion of the mold body, the forming portion being defined by the through-hole and the lower punch; and
a temperature control system for keeping a temperature of the heater higher than an evaporating temperature of the solution, but lower than a melting temperature of the lubricant.
